(19) United States
(12) Patent Application Publication
(10) Pub. No.: US 2023/0395311 A1
(43) Pub. Date: Dec. 7, 2023

(54) COIL COMPONENT

(71) Applicant: SAMSUNG ELECTRO-MECHANICS CO., LTD., Suwon-si (KR)

(72) Inventors: Tae Hyun KIM, Suwon-si (KR); Soon Kwang KWON, Suwon-si (KR); Dong Hwan LEE, Suwon-si (KR); Byeong Cheol MOON, Suwon-si (KR); Boum Seock KIM, Suwon-si (KR)

(73) Assignee: SAMSUNG ELECTRO-MECHANICS CO., LTD., Suwon-si (KR)

(21) Appl. No.: 18/092,483

(22) Filed: Jan. 3, 2023

(30) Foreign Application Priority Data
Jun. 7, 2022 (KR) 10-2022-0068862

(51) Int. Cl. H01F 27/32; H01F 27/29; H01F 27/24; H01F 1/14

(52) U.S. Cl. CPC H01F 27/324; H01F 27/292; H01F 27/24; H01F 1/14

(57) ABSTRACT

A coil component includes a body, a coil disposed within the body, a first insulating layer covering at least a portion of the coil, an external electrode disposed on one surface of the body and connected to the coil at the one surface of the body, and a magnetic layer disposed on the first insulating layer, covering at least a portion of the first insulating layer and spaced apart from the surface of the body, and in which an the external electrode is disposed on the body, connected to the coil, and spaced apart from the magnetic layer. Additionally, the coil component can include a second insulating layer covering at least a portion of the magnetic layer.

### CROSS-REFERENCE TO RELATED APPLICATION(S)

This application claims the benefit of priority to Korean Patent Application No. 10-2022-0068862 filed on Jun. 7, 2022 in the Korean Intellectual Property Office, the disclosure of which is incorporated herein by reference in its entirety.

### BACKGROUND

### 1. Technical Field

The present disclosure relates to a coil component.

### 2. Description of Related Art

An inductor, a coil component, is a passive electronic component used in electronic devices along with a resistor and a capacitor.

As electronic devices have been designed to have high-performance and a reduced size, the number of electronic components used in electronic devices has been increased and sizes thereof have been reduced.

Meanwhile, to improve inductance properties within a reduced size, it may be common to use a material having high magnetic permeability or a high saturation magnetization value as a material of a body of a coil component.

### SUMMARY

An aspect of the present disclosure is to provide a coil component which may have improved inductance properties within a reduced size by additionally disposing a thin-film magnetic layer covering a coil without changing a material of a body.

An aspect of the present disclosure is to provide a coil component which may have the same inductance and also improved Rdc properties by reducing the number of turns of a coil.

An aspect of the present disclosure is to provide a coil component which may have improved Isat properties by increasing a saturation magnetization value through a magnetic layer.

According to an aspect of the present disclosure, a coil component includes a body, a coil disposed within the body, a first insulating layer covering at least a portion of the coil, an external electrode disposed on one surface of the body and connected to the coil at the one surface of the body, and a magnetic layer disposed on the first insulating layer, covering at least a portion of the first insulating layer and spaced apart from the surface of the body, in which the external electrode is spaced apart from the magnetic layer.

According to an aspect of the present disclosure, a coil component includes a body, a coil disposed within the body, a first insulating layer covering at least a portion of the coil, a magnetic layer disposed on the first insulating layer and covering at least a portion of the first insulating layer, a second insulating layer covering at least a portion of the magnetic layer, and an external electrode disposed on the body, connected to the coil, and in contact with the magnetic layer.

According to an aspect of the present disclosure, a coil component includes a body having first and second surfaces opposing each other in a thickness direction; a coil disposed within the body and including a coil pattern and a lead-out portion at one end of the coil pattern; an external electrode disposed on the body and connected to the lead-out portion of the coil; and a first insulating layer covering a portion of the lead-out portion and a portion of the coil pattern. In a region between the first or second surface of the body and the first insulating layer covering the portion of the coil pattern in the thickness direction, a material included in a region adjacent to the coil pattern has magnetic permeability higher than magnetic permeability of a material included in a region adjacent to the first or second surface of the body. In a region between the first or second surface of the body and the first insulating layer covering the portion of the lead-out portion in the thickness direction, a material included in a region adjacent to the lead-out portion has magnetic permeability substantially equal to magnetic permeability of a material included in a region adjacent to the first or second surface of the body.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to a first embodiment of the present disclosure;

FIG. 2 is a cross-sectional diagram taken along line I-I′ in FIG. 1 and an enlarged diagram illustrating region A1;

FIG. 3 is a cross-sectional diagram taken along line II-II′ in FIG. 1;

FIG. 4 is a cross-sectional diagram illustrating a coil component taken along line I-I′ according to a second embodiment, corresponding to FIG. 2;

FIG. 5 is a cross-sectional diagram illustrating a coil component taken along line II-II′ according to a second embodiment, corresponding to FIG. 3;

FIG. 6 is a cross-sectional diagram illustrating a coil component taken along line I-I′ according to a third embodiment and an enlarged diagram illustrating region A2, corresponding to FIG. 2;

FIG. 7 is a cross-sectional diagram illustrating a coil component taken along line II-II′ according to a third embodiment, corresponding to FIG. 3;

FIG. 8 is a cross-sectional diagram illustrating a coil component taken along line I-I′ according to a fourth embodiment, corresponding to FIG. 4; and

FIG. 9 is a cross-sectional diagram illustrating a coil component taken along line II-II′ according to a fourth embodiment, corresponding to FIG. 5.

### DETAILED DESCRIPTION

The terms used in the example embodiments are used to simply describe an example embodiment, and are not intended to limit the present disclosure. A singular term includes a plural form unless otherwise indicated. The terms, “include,” “comprise,” “is configured to,” and the like, of the description are used to indicate the presence of features, numbers, steps, operations, elements, portions or combination thereof, and do not exclude the possibilities of combination or addition of one or more features, numbers, steps, operations, elements, portions or combination thereof. Also, the term “disposed on,” “disposed on,” and the like, may indicate that an element is disposed on or beneath an object, and may not necessarily mean that the element is disposed on the object with reference to a gravity direction.

The term “coupled to,” “combined to,” and the like, may not only indicate that elements are directly and physically in contact with each other, but also include the configuration in which the other element is interposed between the elements such that the elements are also in contact with the other component.

The size and thickness of each component in the drawings may be arbitrarily indicated for ease of description, and thus, the present disclosure is not necessarily limited to the illustrated examples.

In the drawings, an L direction is a first direction or a length direction, a W direction is a second direction or a width direction, a T direction is a third direction or a thickness direction.

Hereinafter, a coil component according to an example embodiment will be described in detail with reference to the accompanying drawings, and in the description with reference to the accompanying drawings, the same or corresponding components may be provided with the same reference numerals and overlapping description thereof will not be provided.

In electronic devices, various types of electronic components may be used, and various types of coil components may be used between the electronic components to remove noise, or for other purposes.

In other words, in electronic devices, a coil component may be used as a power inductor, a high frequency inductor (HF inductor), a general bead, a high frequency bead (GHz bead), a common mode filter, and the like.

### First Embodiment

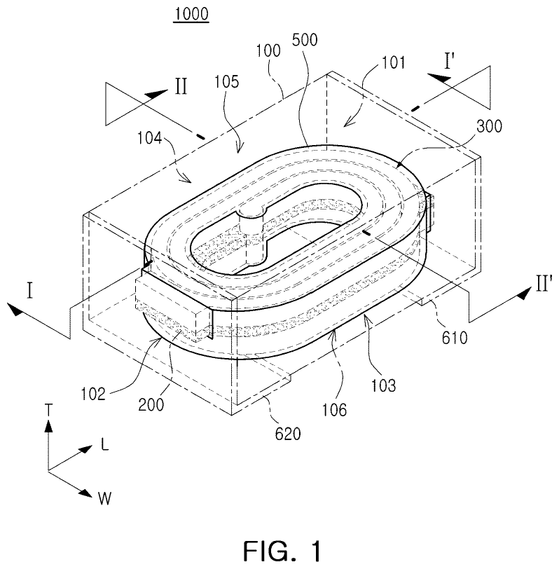

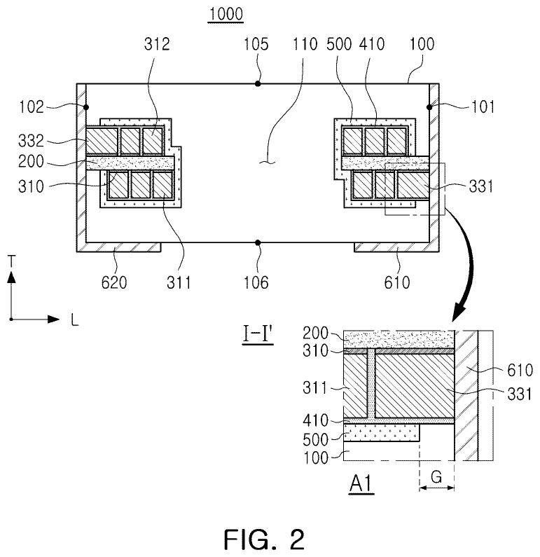

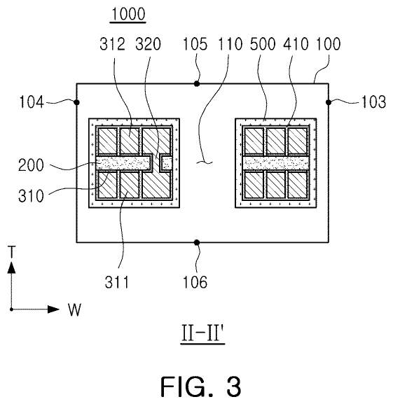

FIG. 1 is a perspective diagram illustrating a coil component according to a first embodiment. FIG. 2 is a cross-sectional diagram taken along line I-I′ in FIG. 1 and an enlarged diagram illustrating region A1. FIG. 3 is a cross-sectional diagram taken along line II-II′ in FIG. 1.

To more clearly illustrate the coupling between the components, the external insulating layer disposed on the body 100 applied to the example embodiment is not illustrated.

Referring to FIGS. 1 to 3, the coil component 1000 according to the first embodiment may include a body 100, a coil 300, a first insulating layer 410, a magnetic layer 500, external electrodes 610 and 620, and may further include a substrate 200.

The body 100 may form an exterior of the coil component 1000 in the example embodiment, and the coil portion 300 may be disposed in the body 100. The coil 300 may be supported by the substrate 200, but an example embodiment thereof is not limited thereto.

The body 100 may have a hexahedral shape.

The body 100 may include a first surface 101 and a second surface 102 opposing each other in the length direction L, a third surface 103 and a fourth surface 104 opposing each other in the width direction W, and a fifth surface 105 and a sixth surface 106 opposing each other in the thickness direction T, with respect to the directions in FIG. 1. Each of the first to fourth surfaces 101, 102, 103 and 104 of the body 100 may be a wall surface of the body 100 connecting the fifth surface 105 to the sixth surface 106 of the body 100. Hereinafter, both end surfaces (one end surface and the other end surface) of the body 100 may refer to the first surface 101 and the second surface 102 of the body 100, both side surfaces (one side surface and the other side surface) of the body 100 may refer to the third surface 103 and the fourth surface 104 of the body 100, and one surface and the other surface of the body 100 may refer to the sixth surface 106 and the fifth surface 105 of the body 100, respectively.

The body 100 may be formed such that the coil component in which the external electrodes 610 and 620 are formed may have a length of 2.5 mm, a width of 2.0 mm and a thickness of 1.0 mm, may have a length of 2.0 mm, a width of 1.2 mm and a thickness of 1.0 mm, may have a length of 2.0 mm, a width of 1.2 mm and a thickness of 0.65 mm, may a length of 1.6 mm, a width of 0.8 mm and a thickness of 0.8 mm, may have a length of 1.0 mm, a width of 0.5 mm and a thickness of 0.5 mm, or may have a length of 0.8 mm, a width of 0.4 mm and a thickness of 0.65 mm, but an example embodiment thereof is not limited thereto. Since the above-described numerical value examples for the length, width, and thickness of the coil component 1000 do not reflect process errors, and a numerical value in a range recognized as a process error may correspond to the above-described numerical value examples.

The length of the above-described coil component 1000 may be a maximum value among dimensions of a plurality of line segments connecting two outermost boundary lines of the coil component 1000, opposing each other in the length direction L, to each other and in parallel to the length direction L, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction L, to each other and in parallel to the length direction L. Alternatively, the length of the coil component 1000 may refer to an arithmetic mean value of at least three or more of the dimensions of the plurality of line segments described above. Here, the plurality of line segments parallel to the length direction L may be spaced apart from each other by an equal distance in the thickness direction T, but an example embodiment thereof is not limited thereto.

The thickness of the above-described coil component 1000 be a maximum value among dimensions of a plurality of line segments connecting two outermost boundary lines of the coil component 1000, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Alternatively, the length of the coil component 1000 may refer to a minimum value among the dimensions of the plurality of line segments connecting two outermost boundary lines of the coil component 1000, opposing each other in the length direction T, to each other and in parallel to the length direction T. Alternatively, the length of the coil component 1000 may refer to an arithmetic mean value of at least three or more of the dimensions of the plurality of line segments described above. Here, the plurality of line segments parallel to the thickness direction T may be spaced apart from each other by an equal distance in the thickness direction T, but an example embodiment thereof is not limited thereto.

The width of the above-described coil component 1000 may be a maximum value among dimensions of a plurality of line segments connecting two outermost boundary lines of the coil component 1000, opposing each other in the width direction W, to each other and in parallel to the width direction W, with respect to an optical microscope image or a scanning electron microscope (SEM) image with respect to a cross-section in the length direction L-width direction W taken from the central portion of the coil component 1000 taken in the thickness direction T. Alternatively, the width of the coil component 1000 may refer to a minimum value among the dimensions of the plurality of line segments connecting two outermost boundary lines of the coil component 1000, opposing each other in the width direction W, to each other and in parallel to the width direction W. Alternatively, the width of the coil component 1000 may refer to an arithmetic mean value of at least three or more of the dimensions of the plurality of line segments connecting two outermost boundary lines of the coil component 1000, opposing each other in the width direction W, to each other and in parallel to the width direction W. Here, the plurality of line segments parallel to the width direction W may be spaced apart from each other by an equal distance in the thickness direction T, but an example embodiment thereof is not limited thereto.

Alternatively, each of the length, width and thickness of the coil component 1000 may be measured by a micrometer measurement method. The micrometer measurement method may be of determining a zero point with a gage repeatability and reproducibility (R&R) micrometer, inserting the coil component 1000 in the example embodiment between tips of the micrometer, and measuring by turning a measuring lever of a micrometer. In measuring the length of the coil component 1000 by the micrometer measurement method, the length of the coil component 1000 may refer to a value measured once or may refer to an arithmetic average of values measured a plurality of times, which may be equally applied to the width and thickness of the coil component 1000.

The body 100 may include an insulating resin and a magnetic material. Specifically, the body 100 may be formed by laminating one or more magnetic composite sheets in which a magnetic material is dispersed in an insulating resin. The magnetic material may be ferrite or a magnetic metal powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni—Co-based ferrite, garnet-type ferrites such as Y-based ferrite, and Li-based ferrites.

A metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an example embodiment thereof is not limited thereto.

Each particle of ferrite and magnetic metal powder may have an average diameter of about 0.1 μm to 30 μm, but an example embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape.

In the description below, the magnetic material may be a magnetic metal powder, but an example embodiment thereof is not limited to the body 100 having a structure in which magnetic metal powder is dispersed in an insulating resin.

The insulating resin may include epoxy, polyimide, a liquid crystal polymer, or the like, alone or in combination but an example embodiment thereof is not limited thereto.

Referring to FIGS. 2 and 3, the body 100 may include a core 110 penetrating through a substrate 200 and a coil 300 to be described later. The core 110 may be disposed in the central region of an innermost turn of the coil 300, that is, the winding central region of the coil 300.

The core 110 may be formed by filling a through-hole penetrating through the center of the coil 300 and the center of the substrate 200 with a magnetic composite sheet including a magnetic material, but an example embodiment thereof is not limited thereto.

The substrate 200 may be disposed in the body 100. The substrate 200 may be configured to support the coil 300 to be described later. Also, a central portion of the substrate 200 may be removed through a trimming process, thereby forming a through-hole, and the core 110 may be disposed in the through-hole. Here, the through-hole formed in the substrate 200 may be formed in a shape corresponding to the shape of the innermost turn of the coil 300.

The substrate 200 may be formed of a thermosetting insulating resin such as an epoxy resin, a thermoplastic insulating resin such as polyimide, or an insulating material including a photosensitive insulating resin, or an insulating material in which the insulating resin is impregnated with a reinforcing material such as glass fiber or inorganic filler. For example, the substrate 200 may be formed of an insulating material such as prepreg, Ajinomoto build-up film (ABF), FR-4, bismaleimide triazine (BT) film, and photo imaginable dielectric (PID) film, but an example embodiment thereof is not limited thereto.

As inorganic fillers, at least one selected from a group consisting of silica (SiO₂), alumina (Al₂O₃), silicon carbide (SiC), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃) and calcium zirconate (CaZrO₃) may be used.

When the substrate 200 is formed of an insulating material including a reinforcing material, the substrate 200 may provide excellent rigidity. When the substrate 200 is formed of an insulating material not including glass fibers, the substrate 200 may be advantageous to reduce the thickness of the coil component 1000 according to the example embodiment. Also, based on the body 100 of the same size, the volume occupied by the coil 300 and/or the magnetic metal powder may be increased, thereby improving component properties. When the substrate 200 is formed of an insulating material including a photosensitive insulating resin, the number of processes for forming the coil 300 may be reduced, which may be advantageous in reducing production costs, and fine vias 320 may be formed.

The thickness of the substrate 200 may be, for example, 10 μm or more and 50 μm or less, but an example embodiment thereof is not limited thereto.

The coil 300 may be disposed in the body 100 and may exhibit properties of the coil component 1000. For example, when the coil component 1000 of the example embodiment is used as a power inductor, the coil 300 may store an electric field as a magnetic field and may maintain an output voltage, thereby stabilizing the power of the electronic device.

The coil component 1000 according to the example embodiment may include a coil 300 supported by the substrate 200 in the body 100. The coil 300 may have at least one turn wound around the core 110.

Referring to FIGS. 1 to 3, the coil 300 may include first and second coil patterns 311 and 312, a via 320, and first and second lead-out portions 331 and 332. Specifically, the first coil pattern 311 and the first lead-out portion 331 may be disposed on one surface of the substrate 200 opposing the sixth surface 106 of the body 100, and the second coil pattern 312 and a second lead-out portion 332 may be disposed on the other surface of the substrate 200 opposing the fifth surface 105 of the body 100, with respect to the direction in FIG. 1.

Referring to FIGS. 1 to 3, each of the first coil pattern 311 and the second coil pattern 312 may have at least one turn about the core 110 as an axis. Each of the first coil pattern 311 and the second coil pattern 312 may have a planar spiral shape.

The first coil pattern 311 may form at least one turn on one surface of the substrate 200 with the core 110 as an axis. The second coil pattern 312 may form at least one turn on the other surface of the substrate 200 with the core 110 as an axis.

Referring to FIG. 3, the coil 300 may include a via 320 penetrating through the substrate 200 and connecting the first and second coil patterns 311 and 312 to each other on both surfaces of the substrate 200.

The via 320 may electrically connect the first and second coil patterns 311 and 312 disposed on both surfaces of the substrate 200 to each other. Specifically, the lower surface of the via 320 may be connected to the end of the innermost turn of the first coil pattern 311, and the upper surface of the via 320 may be connected to the end of the innermost turn of the second coil pattern 312, with respect to the direction in FIG. 1.

Referring to FIGS. 1 to 2, the coil 300 may include first and second lead-out portions 331 and 332 exposed to the first and second surfaces 101 and 102 of the body 100, respectively.

The first lead-out portion 331 may be connected to the first coil pattern 311, may be exposed to the first surface 101 of the body 100, and may be connected to the first external electrode 610 to be described later. Also, the second lead-out portion 332 may be connected to the second coil pattern 312, may be exposed to the second surface 102 of the body 100, and may be connected to the second external electrode 620 to be described later.

That is, the input from the first external electrode 610 may pass through the first lead-out portion 331, the first coil pattern 311, the via 320, the second coil pattern 312, and the second lead-out portion 332 in sequence and may be output through the second external electrode 620.

Accordingly, the coil 300 may function as a single coil between the first and second external electrodes 610 and 620.

At least one of the first and second coil patterns 311 and 312, the via 320, and the first and second lead-out portions 331 and 332 may include at least one conductive layer.

For example, referring to FIGS. 2 to 3, when the first coil pattern 311, the via 320, and the first lead-out portion 331 are formed on one surface of the substrate 200 by plating, each of the first coil pattern 311, the via 320, and the first lead-out portion 331 may include a seed layer 310 and an electrolytic plating layer. Here, the electroplating layer may have a single-layer structure or a multiple-layer structure. The electroplating layer having a multilayer structure may be formed in a conformal film structure in which an electroplating layer is formed along the surface of the other electroplating layer, or an electroplating layer may be laminated only on the other surface of one of the electroplating layers. The seed layer 310 may be formed by an electroless plating method or a vapor deposition method such as sputtering. The seed layers 310 of the first coil pattern 311, the via 320, and the first lead-out portion 331 may be integrally formed such that no boundary may be formed therebetween, but an example embodiment thereof is not limited thereto. The electroplating layers of the first coil pattern 311, the first via 320, and the first lead-out portion 331 may be integrally formed such that a boundary may not be formed therebetween, but an example embodiment thereof is not limited thereto.

Each of the first coil pattern 311, the first via 320, and the first lead-out portion 331 may be formed of a conductive material such as copper (Cu), aluminum (Al), silver (Ag), tin (Sn), gold (Au), nickel (Ni), lead (Pb), titanium (Ti), chromium (Cr), or an alloy thereof, but an example embodiment thereof is not limited thereto.

Referring to FIGS. 2 to 3, the coil component 1000 according to the example embodiment may include a first insulating layer 410. The first insulating layer 410 may cover at least a portion of the coil 300 and may insulate the coil 300 and a magnetic layer 500 from each other.

Specifically, the first insulating layer 410 may be disposed between the coil 300 and the body 100, and may be disposed between the substrate 200 and the body 100. The first insulating layer 410 may be conformally formed along the surfaces of the first and second coil patterns 311 and 312 and the first and second lead-outs 331 and 332, but an example embodiment thereof is not limited thereto.

The first insulating layer 410 may fill a region between turns of the first and second coil patterns 311 and 312 adjacent to each other, and a region between the first and second lead-out portions 331 and 332 and the first and second coil patterns 311 and 312, respectively, and may insulate the coil turns from each other.

The first insulating layer 410 may be provided to insulate the coil 300 and the body 100, and may include a well-known insulating material such as paraline, but an example embodiment thereof is not limited thereto. As another example, the first insulating layer 410 may include an insulating material such as an epoxy resin other than paraline. The first insulating layer 410 may be formed by vapor deposition, but an example embodiment thereof is not limited thereto. As another example, the first insulating layer 410 may be formed by laminating and curing an insulating film for forming the first insulating layer 410 on both surfaces of the substrate 200 on which the coil 300 is disposed, or may be formed by applying and curing an insulating paste for forming the first insulating layer 410 on both surfaces of the substrate 200 on which the substrate 200 is disposed.

Referring to FIGS. 1 to 3, the coil component 1000 according to the example embodiment may include a magnetic layer 500 disposed on the first insulating layer 410 and including a magnetic material.

The magnetic layer 500 may be disposed in the form of a thin film in the body 100 and may adjust magnetic permeability or a saturation magnetization value of the coil component 1000 according to the example embodiment. Specifically, by arranging the magnetic layer 500 in the region in which the magnetic flux around the coil 300 flows in the body 100, desired permeability or a saturation magnetization value may be obtained without changing the material component forming the body 100.

Referring to FIG. 2, the magnetic layer 500 may be disposed on the first insulating layer 410 covering the coil 300. Also, the magnetic layer 500 may be disposed to cover the side surface of the substrate 200 opposing the core 110.

The magnetic layer 500 of the coil component 1000 according to the example embodiment may be disposed to be spaced apart from the external electrodes 610 and 620.

Specifically, referring to the enlarged diagram of region A1 in FIG. 2, the end of the magnetic layer 500 may be disposed to have a predetermined spacing G from the external electrodes 610 and 620. Also, the magnetic layer 500 may be formed such that at least a portion of the first insulating layer 410 disposed on the first and second lead-out portions 331 and 332 may be exposed to the body 100.

The magnetic layer 500 may include a metal component. In the case of the coil component 1000 according to the example embodiment, as the magnetic layer 500 is spaced apart from the external electrodes 610 and 620, a leakage current may be prevented without an additional insulating film, and the effective volume in the coil component 1000 may also be increased.

The magnetic layer 500 may include a magnetic material, and the magnetic layer 500 may include a magnetic material having magnetic permeability higher than that of the material of the body 100, thereby implementing a coil component having high magnetic permeability.

For example, in one embodiment, in a region between the sixth surface 106 of the body 100 and the first insulating layer 410 covering a portion of the first coil pattern 311 in the thickness direction T, a material included in a region adjacent to the first coil pattern 311 may have magnetic permeability higher than magnetic permeability of a material included in a region adjacent to the sixth surface 106 of the body 100. On the other hand, in a region between the sixth surface 106 of the body 100 and the first insulating layer 410 covering a portion of the first lead-out portion 331 in the thickness direction T, a material included in a region adjacent to the first lead-out portion 331 may have magnetic permeability substantially equal to magnetic permeability of a material included in a region adjacent to the sixth surface 106 of the body.

Alternatively, the magnetic layer 500 may include a magnetization material having a saturation magnetization value higher than that of the material of the body 100, thereby increasing the saturation magnetization value and implementing a coil component having improved Isat properties.

The magnetic layer 500 may include a nickel (Ni) component, but an example embodiment thereof is not limited thereto, and may include known magnetization materials exhibiting desired properties such as high magnetic permeability or high saturation magnetization value.

The magnetic layer 500 may include ferrite and/or a metal.

For example, the magnetic layer 500 may include at least one of Mn—Zn-based ferrite, Ni—Zn-based ferrite, Ni—Zn—Cu-based ferrite, Mn—Mg-based ferrite, or Ba-based ferrite and Li-based ferrite, but an example embodiment thereof is not limited thereto.

Also, the magnetic layer 500 may include at least one selected from the group consisting of iron (Fe), silicon (Si), chromium (Cr), aluminum (Al), and nickel (Ni), but an example embodiment thereof is not limited thereto.

Also, the magnetic layer 500 may include a Ni—Fe-based permalloy alloy material, and the composition ratio between Fe—Ni may vary depending on required properties. When the magnetic layer 500 is formed of a material having relatively low magnetic permeability and the body 100 adjacent to the magnetic layer 500 is formed of a material having high permeability, high Isat properties may be obtained and an appropriate Ls value may be maintained.

The magnetic layer 500 may be formed by a vapor deposition method such as sputtering and/or a plating method, but an example embodiment thereof is not limited thereto.

The thickness of the magnetic layer 500 may be preferably formed to a thickness of 2 μm or more and 20 μm or less.

Herein, the thickness of the magnetic layer 500 may refer to, for example, an arithmetic mean value of at least three or more of the dimensions of a plurality of line segments connecting two outermost boundary lines of the magnetic layer 500, opposing each other in the thickness direction T, to each other and in parallel to the thickness direction T, with respect to an optical microscope image or a scanning electron microscope (SEM) image with respect to a cross-section in the length direction L-thickness direction T taken from the central portion of the coil component 1000 taken in the width direction W. Here, the plurality of line segments parallel to the thickness direction T may be spaced spart from each other by an equal distance in the length direction L, but an example embodiment thereof is not limited thereto.

Table 1 below lists the changes in Ls properties of the coil component 1000 depending on the thickness of the magnetic layer 500, and Ls for a coil component in which the magnetic layer 500 may include nickel (Ni) having a magnetic permeability of 600, the body 100 may have a length of 1.475 mm, a width of 1.305 mm, a thickness of 0.58 mm, and may be formed of a material having magnetic permeability of 30 has been measured.

TABLE 1

| Thickness of magnetic | | |
|---|---|---|
| layer (μm) | Ls (nH) | Change rate (%) |
| 0 (ref.) | 341.40 | — |
| 2 | 510.99 | 149.67 |
| 4 | 574.52 | 168.28 |
| 6 | 622.23 | 182.26 |
| 8 | 659.87 | 193.28 |
| 10 | 690.47 | 202.25 |
| 12 | 715.77 | 209.66 |
| 14 | 737.11 | 215.91 |
| 16 | 755.35 | 221.25 |
| 18 | 771.18 | 225.89 |
| 20 | 785.17 | 229.99 |

Referring to Table 1, as a result of the experiment, an increase in Ls approximate to 150% as compared to a general structure was confirmed even when the magnetic layer 500 was formed as an ultra-thin film of 2 μm. Also, when the magnetic layer 500 was formed to have a thickness of 10 μm or more, it was confirmed that Ls increased by 200% or more as compared to a general structure.

The external electrodes 610 and 620 may be disposed on the body 100, may be spaced apart from each other, and may be connected to the coil 300. Specifically, the first external electrode 610 may be disposed on the first surface 101 of the body 100, and may be in contact with and connected to the first lead-out portion 331 extending to the first surface 101 of the body 100, and the second external electrode 620 may be disposed on the second surface 102 of the body 100 and may be in contact with and connected to the second lead-out portion 332 extending to the second surface 102 of the body 100.

The first external electrode 610 may be disposed on the first surface 101 of the body 100 and may extend to at least a portion of the third to sixth surfaces 103, 104, 105, and 106 of the body 100. The second external electrode 620 may be disposed on the second surface 102 of the body 100 and may extend to at least a portion of the third to sixth surfaces 103, 104, 105, and 106 of the body 100.

Referring to FIGS. 1 and 3, the coil component 1000 according to the example embodiment may have a structure in which the first and second external electrodes 610 and 620 disposed on the first surface 101 and the second surface 102 of the body 100, respectively, may extend only to the sixth surface 106 of the body 100.

In this case, the first external electrode 610 may include a first pad portion disposed on the sixth surface 106 of the body 100, and a first extension portion disposed on the first surface 101 of the body 100 and connecting the first lead-out portion 331 to the first pad portion.

Also, the second external electrode 620 may include a second pad portion spaced apart from the first pad portion on the sixth surface 106 of the body 100, and a second extension portion disposed on the second surface 102 of the body 100 and connecting the second lead-out portion 332 to the second pad portion.

The pad portion and the extension portion may be formed together in the same process and may be integrally formed without forming a boundary therebetween, but an example embodiment thereof is not limited thereto.

The external electrodes 610 and 620 may be formed by a vapor deposition method such as sputtering and/or a plating method, but an example embodiment thereof is not limited thereto.

The external electrodes 610 and 620 may be formed of a conductive material such as copper (Cu), aluminum (Al), silver (Ag), tin (Sn), gold (Au), nickel (Ni), lead (Pb), chromium (Cr), titanium (Ti), or an alloy thereof, but an example embodiment thereof is not limited thereto.

The external electrodes 610 and 620 may be formed in a single-layer or multiple-layer structure. For example, the external electrodes 610 and 620 may include a first conductive layer including copper (Cu), a second conductive layer disposed on the first conductive layer and including nickel (Ni), and a third conductive layer disposed on the second conductive layer and including tin (Sn). At least one of the second conductive layer and the third conductive layer may be formed to cover the first conductive layer, but an example embodiment thereof is not limited thereto. The first conductive layer may be a plating layer or a conductive resin layer formed by coating and curing a conductive resin including a conductive powder including at least one of copper (Cu) and silver (Ag) and a resin. The second and third conductive layers may be plating layers, but an example embodiment thereof is not limited thereto.

The coil component 1000 according to the example embodiment may further include an external insulating layer disposed on the third to sixth surfaces 103, 104, 105, and 106 of the body 100. The external insulating layer may be disposed on a region other than the region in which the external electrodes 610 and 620 are disposed among the surfaces of the body 100.

At least a portion of the external insulating layers disposed on each of the third to sixth surfaces 103, 104, 105, and 106 of the body 100 may be formed in the same process, such that the elements may be integrated with each other without a boundary therebetween, but an example embodiment thereof is not limited thereto.

The outer insulating layer may be formed by forming an insulating material for forming the outer insulating layer by a method such as a printing method, vapor deposition, a spray coating method, a film lamination method, or the like, but an example embodiment thereof is not limited thereto.

The outer insulating layer may include a thermoplastic resin such as polystyrene resin, vinyl acetate resin, polyester resin, polyethylene resin, polypropylene resin, polyamide resin, rubber resin, acrylic resin, a thermosetting resin such as phenolic resin, epoxy resin, urethane resin, melamine resin, and alkyd resin, a photosensitive resin, parallen, SiOₓ, or SiNₓ. The outer insulating layer may further include an insulating filler such as an inorganic filler, but an example embodiment thereof is not limited thereto.

### Second Embodiment

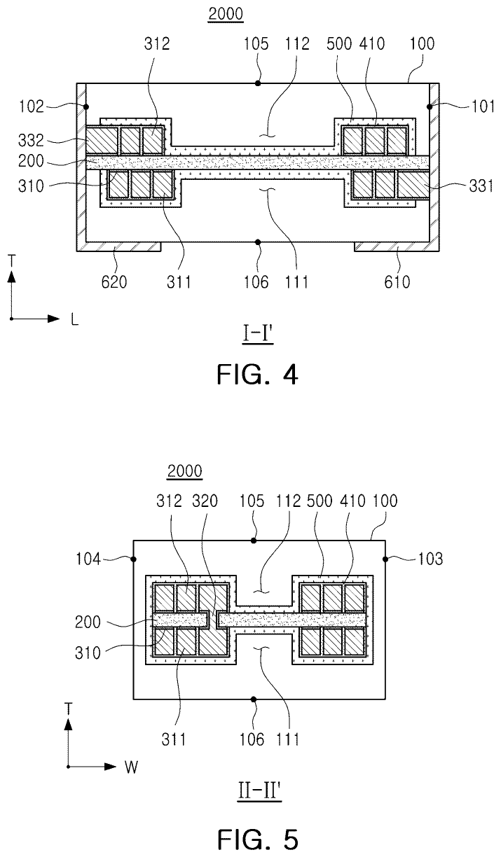

FIG. 4 is a cross-sectional diagram illustrating a coil component taken along line I-I′ according to a second embodiment, corresponding to FIG. 2. FIG. 5 is a cross-sectional diagram illustrating a coil component taken along line II-II′ according to a second embodiment, corresponding to FIG. 3.

Referring to FIGS. 4 to 5, in the coil component 2000 according to the second embodiment, the shape of the substrate 200, the structure in which the core 110 in the through-hole is divided into upper and lower portions, and the area covered by the magnetic layer 500 may be different from those of the coil component 1000 according to the first embodiment.

Therefore, in describing the example embodiment, only the shape of the substrate 200, the upper core 112 and the lower core 111, and the region covered by the magnetic layer 500, different from those of the first embodiment, will be described. For the rest of the components of the example embodiment, the description in the first embodiment may be applied as is.

Referring to FIGS. 4 to 5, in the coil component 2000 according to the example embodiment, the substrate 200 may extend to the through-hole such that the core 110 may be divided into two regions, such that the lower core 111 and the upper core 112 may be included.

Specifically, the substrate 200 may include one surface opposing the sixth surface 106 of the body 100 and the other surface opposing the fifth surface 105 of the body 100, and the core 110 may include the lower core 111 disposed on one surface of the substrate 200 and surrounded by the first coil pattern 610, and the upper core 112 disposed on the other surface of the substrate 200 and surrounded by the second coil pattern 620.

Referring to FIGS. 4 to 5, a magnetic layer 500 may be disposed between one surface of the substrate 200 and the lower core 111, and between the other surface of the substrate 200 and the upper core 112.

Specifically, the magnetic layer 500 covering the first coil pattern 311 and the first lead-out portion 331 may extend to the region of one surface of the substrate 200 in which the lower core 111 is disposed, and the magnetic layer 500 covering the second coil pattern 312 and the second lead-out portion 332 may extend to the region of the other surface of the substrate 200 in which the upper core 112 is disposed.

Since the magnetic flux density penetrating through the coil 300 is relatively large in the central region of the turn, by disposing the magnetic layer 500 in the core 110 region as in the coil component 2000 according to the embodiment, the effect of increasing magnetic permeability or a saturation magnetization value may be enhanced.

Also, since the process of forming the through-hole by trimming the central region of the substrate 200 may also not be performed, defects such as deformation of the coil 300 occurring when the through-hole is formed may be reduced.

### Third and Fourth Embodiments

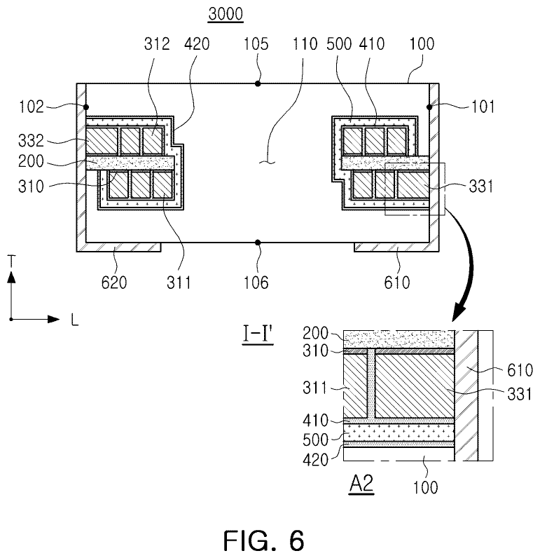

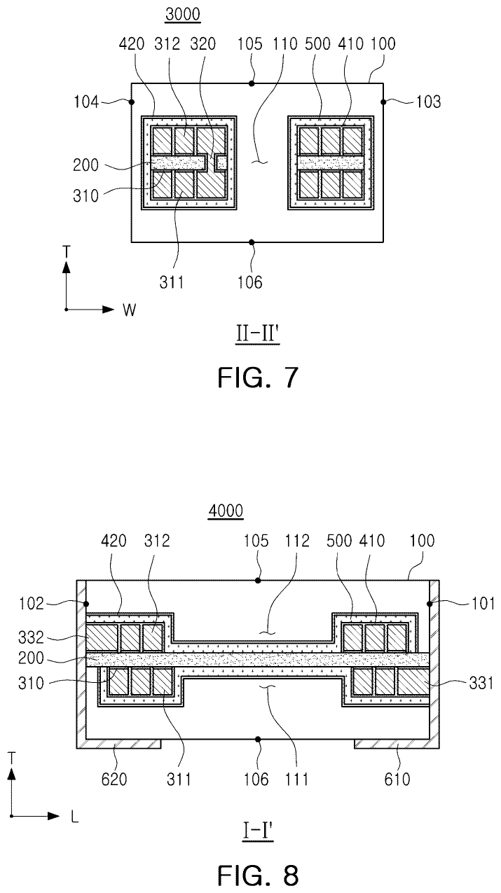

FIG. 6 is a cross-sectional diagram illustrating a coil component taken along line I-I′ according to a third embodiment and an enlarged diagram illustrating region A2, corresponding to FIG. 2. FIG. 7 is a cross-sectional diagram illustrating a coil component taken along line II-II′ according to a third embodiment, corresponding to FIG. 3.

Referring to FIGS. 6 to 7, in the coil component 3000 according to the third embodiment, whether there may be a distance between the external electrodes 610 and 620, and the configuration in which the second insulating layer 420 may be further included may be different from the coil component 1000 according to the first embodiment.

Therefore, in describing the example embodiment, only the structure in which the magnetic layer 500 is in contact with the external electrodes 610 and 620, and the second insulating layer 420, different from the first embodiment, will be described. For the rest of the components of the example embodiment, the description in the first embodiment may be applied as is.

Referring to FIGS. 6 to 7, the magnetic layer 500 of the coil component 3000 according to the example embodiment may be disposed to be in contact with the external electrodes 610 and 620.

Specifically, referring to the enlarged diagram of region A2 in FIG. 6, an end of the magnetic layer 500 may be in direct contact with and connected to the external electrodes 610 and 620. Also, the magnetic layer 500 may be disposed to entirely cover the first insulating layer 410 disposed on the first and second lead-out portions 331 and 332.

The coil component 3000 according to the example embodiment may further include a second insulating layer 420 covering at least a portion of the magnetic layer 500.

In the coil component 3000 according to the example embodiment, the second insulating layer 420 may insulate the magnetic layer 500 and the body 100 from each other, such that leakage current which may occur when the magnetic layer 500 is connected to the external electrodes 610 and 620 may be reduced.

Specifically, the second insulating layer 420 may be disposed between the magnetic layer 500 and the body 100, and be conformally formed along the surface of the magnetic layer 500 disposed on the coil 300. However, the example embodiment thereof is not limited thereto.

The second insulating layer 420 may include a well-known insulating material such as paraline, but an example embodiment thereof is not limited thereto. As another example, the second insulating layer 420 may include an insulating material such as an epoxy resin other than paraline. The second insulating layer 420 may be formed by vapor deposition, but an example embodiment thereof is not limited thereto. As another example, the second insulating layer 420 may be formed by laminating and curing an insulating film for forming the second insulating layer 420 on both surfaces of the substrate 200 on which the coil 300 is disposed, or may be formed by applying and curing an insulating paste for forming the second insulating layer 420 on both surfaces of the substrate 200 on which the coil 300 is disposed.

Referring to FIGS. 6 to 7, the magnetic layer 500 may be disposed to cover the entire first insulating layer 410 disposed on the first and second lead-out portions 331 and 332 without exposing the first insulating layer 410. That is, the other surfaces of the first and second lead-out portions 331 and 332 other than the surfaces in contact with the first and second external electrodes 610 and 620, respectively, may be covered by the first insulating layer 410, the magnetic layer 500, and the second insulating layer 420 in order.

In the coil component 3000 according to the example embodiment, by disposing the magnetic layer 500 up to the outer portion of the coil 300 through which the magnetic flux passes, that is, the region around the first and second lead-out portions 331 and 332, the effects such as improvement of magnetic permeability or improvement of saturation magnetization value by the magnetic layer 500 may be further increased.

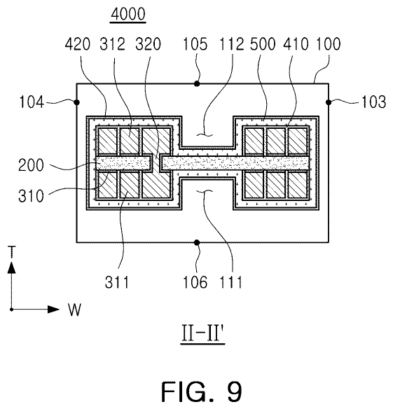

FIG. 8 is a cross-sectional diagram illustrating a coil component taken along line I-I′ according to a fourth embodiment, corresponding to FIG. 4. FIG. 9 is a cross-sectional diagram illustrating a coil component taken along line II-II′ according to a fourth embodiment, corresponding to FIG. 5.

Referring to FIGS. 8 to 9, in the coil component 4000 according to the fourth embodiment, the shape of the substrate 200, the region covered by the magnetic layer 500, and the region covered by the second insulating layer 420 may be different from those of the coil component 3000 according to the third embodiment.

Therefore, in describing the example embodiment, only the shape of the substrate 200 the region covered by the magnetic layer 500, and the second insulating layer 420, different from the third embodiment, will be described. For the rest of the components of the example embodiment, the description in the first embodiment may be applied as is. Referring to FIGS. 8 to 9, in the coil component 4000 according to the example embodiment, the substrate 200 may extend to the through-hole such that the core 110 may be divided into two regions, such that the lower core 111 and the upper core 112 may be included.

Specifically, the core 110 may include the lower core 111 disposed on one surface of the substrate 200 and surrounded by the first coil pattern 610, and the upper core 112 disposed on the other surface of the substrate 200 surrounded by the second coil pattern 620.

Referring to FIGS. 8 to 9, a magnetic layer 500, and a second insulating layer 420 covering the magnetic layer 500 may be disposed between one surface of the substrate 200 and the lower core 111, and between the other surface of the substrate 200 and the upper core 112.

Specifically, the magnetic layer 500 covering the first coil pattern 311 and the first lead-out portion 331 and the second insulating layer 420 covering the magnetic layer 500 may extend to the region of one surface of the substrate 200 in which the lower core 111 is disposed, and the magnetic layer 500 covering the second coil pattern 312 and the second lead-out portion 332 and a second insulating layer 420 covering the magnetic layer 500 may extend to the region of other surface of the substrate 200 in which the upper core is disposed.

That is, the coil component 4000 according to the example embodiment, magnetic layer 500 and the second insulating layers 420 may be disposed between the substrate 200 and the lower core 111, or between the substrate 200 and the upper core 112.

Since the magnetic flux density passing through the coil 300 may be relatively large in the central region of the turn, by disposing the magnetic layer 500 in the core 110 region as in the coil component 4000 according to the example embodiment, the effect of increasing magnetic permeability or a saturation magnetization value may be further enhanced.

Also, since the process of forming the through-hole by trimming the central region of the substrate 200 may also not be performed, defects such as deformation of the coil 300 occurring when the through-hole is formed may be reduced.

Meanwhile, since the coil component 4000 according to the example embodiment may have a structure in which the magnetic layer 500 is extended to be in contact with the first and second external electrodes 610 and 620, the magnetic layer 500 may be disposed up to the outer portion of the coil 300 through which the magnetic flux passes, that is, the region around the first and second lead-out portions 331 and 332, such that the effect of improving the magnetic permeability or the saturation magnetization value by the magnetic layer 500 may be further increased.

According to the aforementioned example embodiments, even without changing the material of a body, by additionally disposing the thin-film magnetic layer covering the coil, inductance properties of the coil component may improve within the reduced size.

Also, since the number of turns of the coil may be reduced while having the same inductance, Rdc of the coil component may be reduced.

Also, since the saturation magnetization value is increased such that inductance properties may be maintained at a high current, Isat properties of the coil component may improve.

While the example embodiments have been illustrated and described above, it will be apparent to those skilled in the art that modifications and variations could be made without departing from the scope of the present disclosure as defined by the appended claims.

What is claimed is:

1. A coil component, comprising:
a body;
a coil disposed within the body;
a first insulating layer covering at least a portion of the coil;
an external electrode disposed on one surface of the body and connected to the coil at the one surface of the body; and
a magnetic layer disposed on the first insulating layer, covering at least a portion of the first insulating layer and spaced apart from the surface of the body,
wherein the external electrode is spaced apart from the magnetic layer.

2. The coil component of claim 1, wherein a material of the magnetic layer has magnetic permeability higher than magnetic permeability of a material of the body.

3. The coil component of claim 1, wherein a material of the magnetic layer has a saturation magnetization value larger than a saturation magnetization value of a material of the body.

4. The coil component of claim 1, wherein the magnetic layer includes at least one of nickel (Ni), iron (Fe), silicon (Si), chromium (Cr), or aluminum (Al).

5. The coil component of claim 1, wherein at least a portion of the magnetic layer is in contact with the first insulating layer.

6. The coil component of claim 1, wherein the body includes a core disposed in a central region of an innermost turn of the coil.

7. The coil component of claim 6, further comprising:
a substrate disposed within the body;
wherein the coil is disposed on at least one surface of the substrate.

8. The coil component of claim 7, wherein the core penetrates the substrate.

9. The coil component of claim 7, wherein at least a portion of the magnetic layer is in contact with the first insulating layer and the substrate.

10. The coil component of claim 7,
wherein the coil includes first and second coil patterns disposed on opposing surfaces of the substrate, a via penetrating through the substrate and connecting the first and second coil patterns to each other, and first and second lead-out portions extending from outermost turns of the first and second coil patterns, respectively, and
wherein the external electrode includes first and second external electrodes connected to the first and second lead-out portions, respectively.

11. The coil component of claim 10, wherein the magnetic layer exposes at least a portion of the first insulating layer disposed on the first and second lead-out portions.

12. The coil component of claim 10,
wherein the substrate includes a first surface and a second surface opposing each other, and
wherein the core includes a lower core disposed on the first surface of the substrate and surrounded by the first coil pattern, and an upper core disposed on the second surface of the substrate and surrounded by the second coil pattern.

13. The coil component of claim 12, wherein the magnetic layer is disposed between the first surface of the substrate and the lower core, and between the second surface of the substrate and the upper core.

14. A coil component, comprising:
a body;
a coil disposed within the body;
a first insulating layer covering at least a portion of the coil;
a magnetic layer disposed on the first insulating layer and covering at least a portion of the first insulating layer;
a second insulating layer covering at least a portion of the magnetic layer; and
an external electrode disposed on the body, connected to the coil, and in contact with the magnetic layer.

15. The coil component of claim 14, wherein a material of the magnetic layer has magnetic permeability higher than magnetic permeability of a material of the body.

16. The coil component of claim 14, wherein a material of the magnetic layer has a saturation magnetization value greater than a saturation magnetization value of a material of the body.

17. The coil component of claim 14, further comprising:
a substrate disposed within the body,
wherein the body includes a core disposed in a central region of an innermost turn of the coil, and
wherein the coil is disposed on at least one surface of the substrate.

18. The coil component of claim 17, wherein the core penetrates the substrate.

19. The coil component of claim 17,
wherein the substrate includes a first surface and a second surface opposing each other,
wherein the core includes a lower core disposed on the first surface of the substrate and surrounded by an innermost turn of the coil, and an upper core disposed on the second surface of the substrate and surrounded by an innermost turn of the coil, and
wherein the magnetic layer is disposed between the first surface of the substrate and the lower core, and between the second surface of the substrate and the upper core.

20. A coil component, comprising:
a body having first and second surfaces opposing each other in a thickness direction;
a coil disposed within the body and including a coil pattern and a lead-out portion at one end of the coil pattern;
an external electrode disposed on the body and connected to the lead-out portion of the coil; and
a first insulating layer covering a portion of the lead-out portion and a portion of the coil pattern,
wherein, in a region between the first or second surface of the body and the first insulating layer covering the portion of the coil pattern in the thickness direction, a material included in a region adjacent to the coil pattern has magnetic permeability higher than magnetic permeability of a material included in a region adjacent to the first or second surface of the body, and
wherein, in a region between the first or second surface of the body and the first insulating layer covering the portion of the lead-out portion in the thickness direction, a material included in a region adjacent to the coil pattern has magnetic permeability substantially equal to magnetic permeability of a material included in a region adjacent to the first or second surface of the body.

21. The coil component of claim 20, wherein, in the region between the first or second surface of the body and the first insulating layer covering the portion of the coil pattern in the thickness direction, the material included in the region adjacent to the coil pattern has a saturation magnetization value larger than a saturation magnetization value of the material included in the region adjacent to the first or second surface of the body.

22. The coil component of claim 20, wherein the body includes a core disposed in a central region of an innermost turn of the coil.

23. The coil component of claim 22, further comprising:
a substrate disposed within the body;
wherein the coil is disposed on at least one surface of the substrate.

24. The coil component of claim 23, wherein the core penetrates the substrate.
